(19) United States
(12) Patent Application Publication
(10) Pub. No.: US 2024/0151260 A1
(43) Pub. Date: May 9, 2024

(54) LOCKABLE CARABINER FOR MOUNTAINEERING AND WORK AT HEIGHTS AND METHOD FOR OPENING ONE SUCH CARABINER

(71) Applicant: ZEDEL, Crolles (FR)

(72) Inventors: Pierre PLAZE, Cruet (FR); Landry VERTU, Filliere (FR)

(73) Assignee: ZEDEL, Crolles (FR)

(21) Appl. No.: 18/383,623

(22) Filed: Oct. 25, 2023

(30) Foreign Application Priority Data
Nov. 6, 2022 (FR) 2211525

(51) Int. Cl. F16B 45/02

(52) U.S. Cl. CPC F16B 45/026; F16B 45/023; F16B 45/028

(57) ABSTRACT

A carabiner comprises a body and a gate fixed to the body to be movable between closed and open positions. A catch is fixed to the body and installed movable between a blocking position and a release position of the gate in the closed position. A first spring is connected to the gate and to the catch. The first spring biases the gate to the closed position and biases the catch to the blocking position. In the closed position, the first spring is curved with a first mean radius of curvature. In the open position, the first spring is curved with a second mean radius of curvature that is larger than the first radius of curvature.

### BACKGROUND OF THE INVENTION

The invention relates to a lockable carabiner for mountaineering and work at heights and to a method for opening one such carabiner.

### PRIOR ART

Carabiners are known that have a body and a gate installed movable with respect to the body between an open position and a closed position. In the open position, it is possible to insert an item, for example a rope, in the hook formed by the body. In the closed position, it is not possible to insert an item in the hook formed by the body or to withdraw an item from the carabiner.

It is advantageous to prevent unintentional opening of the carabiner by associating a blocking means of the gate. Different configurations of blocking means have been used that prevent the gate from being opened so long as the blocking means are in the blocking position.

It is known to manufacture carabiners with a gate that defines a blind cavity receiving a spring biasing the gate to a closed position. The hole formed in the gate has an effect on the mechanical strength such that it is necessary to form a thick gate to achieve high mechanical performances. The hole formed in the gate also has the effect of retaining dust, moisture and mud which is detrimental to a good lifespan of the carabiner. It is therefore advantageous to seek to provide another carabiner configuration.

The applicant markets carabiners equipped with a swivelling gate and a locking system. The gate is formed by a U-shaped metal plate associated with a torsion spring that biases the gate to the closed position. The torsion spring presses on the one hand on the body and on the other hand on the gate. The carabiner is provided with a blocking system with a catch installed swivelling with respect to the body. A substantially identical configuration is marketed under the tradename EASHOOK. Depending on the environment of use, the lifespan of the spring can vary greatly as the latter is in contact with dust and mud.

The document US 2014/0230199 discloses a hook-carabiner for work at heights. The carabiner is provided with a swivelling gate and a swivelling locking member. The gate and locking member are fixed to a C-shaped body. The body defines a hook. When the locking member is in the blocking position, the locking member prevents swivelling of the gate which prevents the gate from being actuated. The locking member is biased to the blocking position by means of a compression coil spring that is secured to the body and to the locking member. The gate is biased to the closed position by a torsion spring that presses on the body and on the gate.

Such a configuration makes it difficult to achieve a carabiner that is compact and able to withstand strong forces. The body does in fact have to withstand the forces along the major axis of the hook and along the minor axis of the hook. The body also has to be shaped to withstand the forces applied by the springs. To withstand all the forces applied on the body, a thick body has to be formed. Such a configuration is not practical to use as the carabiner is thick. The carabiner is complicated to manufacture which increases the manufacturing cost and makes the carabiner sensitive to malfunctioning of the multiple components.

### OBJECT OF THE INVENTION

One object of the invention consists in providing a carabiner that presents a better trade-off between compactness and lifespan of the carabiner in comparison with the configurations of the prior art.

According to one feature of the invention, the carabiner comprises:
a C-shaped body provided with a first end portion and a second end portion connected by a central portion;
a gate having a first end and a second end, the first end of the gate being fixed to the first end of the body, the gate being installed swivelling between a closed position and an open position, the second end of the gate moving with respect to to the second end of the body when the gate moves between the open position and the closed position, the gate and the body defining a ring when the gate is in the closed position;
a catch fixed to the body and fitted movable between a blocking position and a release position, the blocking position blocking the gate in the closed position, the release position allowing movement of the gate between the closed position and the open position;
a first spring and a second spring each having a first end connected to the gate and a second end connected to the catch, the first spring and second spring each biasing the gate so that a rest position of the gate is the closed position and biasing the catch so that a rest position of the catch is the blocking position, the first spring and second spring not having a direct attachment point with the body.

The first spring and second spring are separated by the body.

In advantageous manner, the first spring and second spring have the same length and the same stiffness.

In a particular configuration, the gate has a first wing and a second wing, the body being arranged between the first wing and the second wing in the open position and in the closed position.

In an advantageous development, the first wing and second wing of the gate present a coverage surface with the body that is larger in the open position than in the closed position, the coverage surface being observed in a direction parallel to the swivel axis of the gate.

Preferentially, the first wing and second wing slide against the body.

According to one embodiment, the catch is U-shaped comprising two wings connected by a joining wall, the catch and the body defining a cavity receiving the first spring and the second spring.

In an advantageous development, the first wing of the gate is arranged between the body and the first wing of the catch. The second wing of the gate is arranged between the body and the second wing of the catch.

Preferentially, the cavity receiving the first spring and second spring is delineated by the first wing and second wing of the gate, the first wing of the catch sliding against the first wing of the gate and the second wing of the catch sliding against the second wing of the gate.

In another advantageous development, in the release position, the joining wall is pressing against the body.

In an advantageous development, the gate is installed swivelling around a first swivel axis and the first end of the first spring is terminated by a head installed swivelling around a swivel axis that is parallel to the first swivel axis.

Preferentially, the first spring is a coil spring with non-contiguous turns. A few turns of the first end are blocked by the head to prevent flexion of said a few turns.

In a particular embodiment, in the open position, the head is up against an end-of-travel stop defined by the body.

Advantageously, the body defines an aperture and the head extends on each side of the body through the aperture to receive the first end of the first spring and the first end of the second spring.

In preferential manner, the gate is installed swivelling with respect to the body around a first pivot shaft and the catch is installed swivelling with respect to the body around a second pivot shaft. The first end presses on the gate at a first distance from the first pivot shaft and the second end presses on the catch at a second distance from the second pivot shaft, the second distance being smaller than the first distance. A pin connecting the first pivot shaft and the second pivot shaft is arranged totally on one side of a plane passing through the first spring and the second spring.

It is also advantageous to provide for the gate to define a slide, the slide being installed swivelling with respect to the body when the gate moves between the closed position and the open position. The catch possesses a rod, the rod being installed movable with respect to the body and with respect to the slide when the catch moves between the blocking position and the release position, the slide being arranged on the same side of the central portion as the second end of the gate in an observation in a direction parallel to the swivel axis of the gate.

It is a further object of the invention to provide a method for opening a carabiner that is easy to implement.

This result tends to be achieved by means of a method comprising the following steps:
providing a carabiner according to any one of the foregoing configurations;
moving the catch from the blocking position to the release position;
moving the gate from the closed position to the open position.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a side view of a carabiner with its gate in the closed position and its catch in the blocking position;

FIG. 2 schematically illustrates a cross-sectional view of a carabiner in the plane BB;

FIG. 3 schematically illustrates a longitudinal sectional view of the carabiner with its gate in the closed position and its catch in the blocking position;

FIG. 4 schematically illustrates a longitudinal sectional view of the carabiner with its gate in the closed position and its catch in the release position;

FIG. 5 schematically illustrates a longitudinal sectional view of the carabiner with its gate in an open position and its catch in the release position;

FIG. 6 schematically illustrates a longitudinal sectional view of the carabiner with its gate in an open position and its catch in the release position;

FIG. 7 schematically illustrates an exploded view of the carabiner.

### DESCRIPTION OF THE EMBODIMENTS

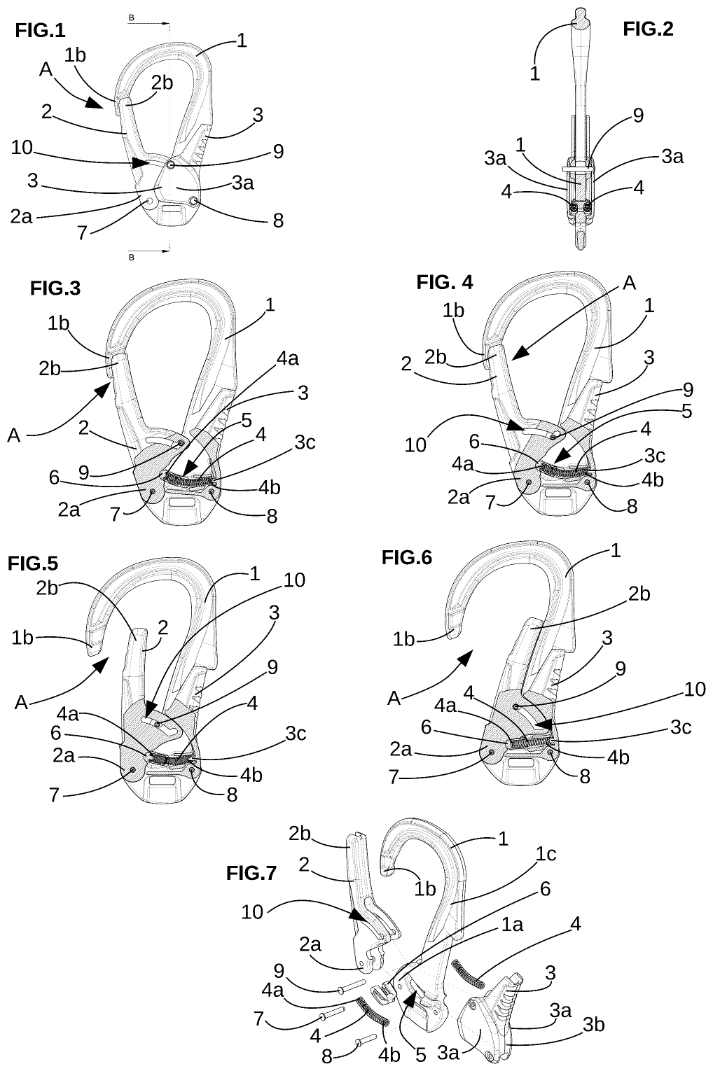

FIGS. 1 to 7 illustrate different embodiments of a carabiner for mountaineering and work at heights. The carabiner has a body 1 and a gate 2 fixed to the body 1. The body 1 is a C-shaped body and is provided with a first end portion 1a and a second end portion 1b connected by a central portion 1c. The gate 2 has a first end 2a and a second end 2b. The first end 2a of the gate 2 is fixed to the first end portion 1a of the body 1.

The gate 2 is installed movable between a closed position and an open position. The gate 2 is preferably installed swivelling. The second end 2b of the gate 2 moves with respect to the second end portion 1b of the body 1 when the gate 2 moves between the open position and the closed position. It is particularly advantageous for the gate 2 to move towards the central portion 1c when the gate 2 moves from the closed position to the open position. In other words, the gate 2 moves towards the recess of the hook from the closed position to the open position. This configuration is more advantageous than that where the gate 2 moves outwards. This also makes it possible to more easily provide a carabiner with a larger opening of the gate 2 without too greatly increasing the overall size of the carabiner and enabling a good strength to be achieved.

In the open position illustrated in FIGS. 5 and 6, the body 1 and the gate 2 define a slot A. The slot A is delineated both by the second end portion 1b of the body 1 and by the gate 2. In the closed position, the gate 2 closes the slot A to define a ring with the body 1. In preferential manner, in the closed position, the two ends of the gate 2 are in contact with the two ends of the body 1. This embodiment is advantageous as it enables a carabiner to be formed that is firmly fastened in the closed position while limiting the size of the gate 2. In the closed position, the carabiner defines a ring that can be of any shape. The closed position is illustrated in FIGS. 1, 3 and 4. The open position is illustrated in FIGS. 5 and 6. In the open position, the body 1 defines a hook.

The carabiner has a catch 3 that is fixed to the body 1 and that is installed movable between a blocking position and a release position. The catch 3 is functionally connected to the gate 2. In the blocking position, the catch 3 blocks the gate 2 in the closed position. In the release position, the catch 3 allows movement of the gate 2 between the closed position and the open position. The catch 3 is distinct from the gate 2. The catch 3 can be installed movable by pivoting or in translation with respect to the body 1. The blocking position is illustrated in FIGS. 1 and 3. The release position is illustrated in FIGS. 4 to 6. For example purposes, the open position of the gate 2 requires the catch 3 to be in the release position.

The carabiner has a first spring 4 that is provided with a first end 4a functionally connected to the gate 2 and a second end 4b functionally connected to the catch 3. The first spring 4 is preferably a compression spring, more preferentially a compression coil spring. In preferential manner, the carabiner has a first spring 4 and a second spring 4 that are each provided with a first end 4a functionally connected to the gate 2 and a second end 4b functionally connected to the catch 3. The two springs can be compression coil springs.

In a rest position, the first spring 4 or each spring 4 biases the gate 2 to the closed position and biases the catch 3 to the blocking position. In a preferential embodiment, the first spring 4 or each spring 4 is devoid of any direct attachment point with the body 1. In other words, the first spring 4 or each spring 4 is totally movable with respect to the body 1. This makes it possible to form a more compact carabiner as it is not necessary to configure a part of the body 1 to withstand the forces of the first spring 4 or of each spring 4. The first spring 4 or each spring 4 is installed movable with respect to the body 1 so as to be able to deform between its two ends without an attachment point with the body 1.

Biasing of the catch 3 to move the catch 3 from the blocking position to the release position corresponds to application of a force on the catch 3 and therefore to application of a force on the first spring 4 or on each spring 4. The force is preferably a compression force of the first spring 4. The force applied by the catch 3 on the first spring 4 or each spring 4 results in a force applied on the gate 2 to keep the latter in the closed position. The force applied on the gate 2 to move the latter from the closed position to the open position results in application of an additional force on the catch 3 to move the catch 3 to the blocking position. The force is preferably a compression force of the first spring 4 or each spring 4. The force applied on the gate 2 to move from the closed position to the open position is in the opposite direction to the force applied on the catch 3 to move from the blocking position to the release position.

The first spring 4 or each spring 4 is functionally fixed on the one hand to the gate 2 and on the other hand to the catch 3 which enables the same spring to be used for the two consecutive operations necessary for opening the gate 2.

FIG. 3 illustrates a carabiner with a catch 3 in the blocking position and a gate 2 in the closed position. FIG. 4 illustrates a carabiner with a catch in the release position and a gate 2 in the closed position. The force applied on the catch 3 deforms the first spring 4 or each spring 4. The force applied on the catch 3 results in a stronger force applied by the first spring 4 or each spring 4 on the gate 2 to keep the latter in the closed position. FIG. 5 illustrates a carabiner with a catch in the release position and a gate 2 having left the closed position and moving towards a fully open position. Forces are applied on the two opposite ends of the first spring 4 to strain the latter in compression. FIG. 6 illustrates a carabiner with a catch in the release position and a gate 2 having left the closed position to reach a fully open position. Forces are applied on the two opposite ends of the first spring 4 to strain the latter in compression.

To provide a carabiner that presents a better trade-off between mechanical strength and compactness, it is advantageous to have a body 1 that is in a central position with respect to the attachment points of the gate 2. In other words, the body 1 is installed between two side walls of the gate 2. The gate 2 has a U-shaped area that receives a part of the body 1 to perform attachment of the gate 2 on the body 1. This configuration is advantageous as regards a body having two opposite flanges between which the gate is located.

Preferentially, the gate 2 is provided with a first wing 2c and a second wing 2c that are arranged on each side of the body 1, to enhance the strength of the gate 2 in particular throughout the movement phase of the gate 2. The first wing 2c and the second wing 2c are facing the body 1 when the gate 2 is in the closed position and in the open position. It is advantageous for the wings to be continually facing the body 1 between the open position and the closed position thereby limiting the movement of the gate 2 with respect to the body 1 in a direction that is parallel to the swivel axis of the gate 2.

Preferentially, in the closed position, the body 1 and the gate 2 provided with its two wings define a through hole. The through hole enables mud or dust to pass through the hole. This limits retainment of mud and dust inside the carabiner throughout movement of the gate. In comparison, the document US 2014/0230199 discloses a carabiner with two independent snap hooks, malfunctioning of one of which results in malfunctioning of the whole of the carabiner. The torsion spring is arranged to collect all the dust and mud that slide along the body 1. When a foreign body penetrates into the body from the turn delineated between the gate and the body, it is almost no longer possible to extract the latter. The dust and mud remain stuck inside the body which can rapidly impair the functioning of the springs. These problems do not exist in the hoisting field as carabiners work mainly with the hook directed downwards.

In preferential manner, the catch 3 has a first wing 3a and a second wing 3a that are connected by a joining wall 3b. The catch 3 is U-shaped and the body 1 is arranged between the first wing 3a and the second wing 3a. The first spring 4 is arranged between the body 1 and the first wing 3a. The body 1 and the first wing 3a define a cavity that receives the first spring 4. The first wing 3a slides on the body 1 or is located very close to the lateral surface of the body 1 thereby limiting penetration of mud or dust in the immediate proximity of the first spring 4. When the carabiner has a first spring 4 and a second spring 4, the two springs are separated by the body 1. It is preferable for the catch 3 to be U-shaped. The first wing 3a, the second wing 3a and the body 1 define at least one cavity, for example one cavity or two cavities receiving the spring or springs. A single cavity, for example delineated in a C-shape, can receive two springs 4.

In a particular embodiment, the gate 2 has two wings 2c that cover the body 1 and the catch 3 has two wings 3a that cover the body 1. In preferential manner, the first wing 2c of the gate 2 is arranged between the body 1 and the first wing 3a of the catch 3. Advantageously, the second wing 2c of the gate 2 is arranged between the body 1 and the second wing 3a of the catch 3. In a preferential configuration, the cavity that receives the first spring 4 is delineated by the body 1, the first wing 2c of the gate 2 and the first wing 3a of the catch 3. The first wing 3a of the catch 3 can be installed sliding against a surface of the first wing 2c of the gate 2 to limit penetration of mud and dust from the outside to the inside of the cavity.

In preferential manner, in the blocking position and in the release position, the first wing 3a and possibly the second wing 3a of the catch 3 are facing the body 1.

The volume of the cavity is larger when the gate 2 is in the closed position than in the open position. The volume of the cavity is larger when the catch 3 is in the blocking position than in the release position.

In order to protect springs 4, it is advantageous to install each spring 4 in a cavity. The cavity is delineated on the one hand by the body 1 and on the other hand by a first wing 3a and a second wing 3a.

By using two wings of the catch 3 that are installed facing the body 1 and are separated from the body 1 by the wings of the gate 2, the apertures that exist between wings 3a and the body 1 are smaller than the openings of the prior art which makes it more complicated for mud or dust to get into the carabiner. The springs 4 are better protected.

As illustrated in FIGS. 3 to 7, the body 1 at least partly defines a first housing 5 that receives the first spring 4. The first housing 5 is curved. The first spring 4 is curved between its two ends to follow the curvature of the first housing 5. In the illustrated embodiments, the first housing 5 is formed partly by the body 1 and partly by the catch 3. In preferential manner, the body 1 defines a first groove that at least partly forms the housing receiving the first spring 4. It is advantageous to have a second groove at least partly forming the housing receiving second spring 4.

To facilitate actuation of the catch 3 prior to actuation of the gate 2 to obtain opening of the gate 2, it is particularly advantageous to have a first spring 4 that is curved between its two ends 4a/4b. In the closed position, the first spring 4 defines an arc of a circle with a constant radius of curvature or several different radii of curvature between the two ends.

In the closed position, the first spring 4 presents a first mean radius of curvature value along the arc of a circle that extends from the first end 4a to the second end 4a. In the open position, the first spring 4 presents a second mean radius of curvature value along the arc of a circle that extends from the first end 4a to the second end 4a. The second radius of curvature value is different from the first radius of curvature value. Preferentially, the first value is smaller than the second value.

It is also advantageous for the mean radius of curvature defined by the first spring 4 when the catch 3 is in the blocking position and the gate 2 is in the closed position to be different from the mean radius of curvature defined by the first spring 4 when the catch 3 is in the release position and the gate 2 is in the open position, for example fully open. The variation of the radius of curvature enables the mechanical behaviour of the first spring 4 to be modified.

The first end 4a of the first spring 4 is functionally connected to the gate 2. The first end 4a of the first spring 4 moves when the gate 2 moves. The second end 4a of the first spring 4 is functionally connected to the catch 3. The second end 4a of the first spring 4 moves when the catch 3 moves. The force provided by the first spring 4 presses the first end 4a against the gate 2 and the second end 4a against the catch 3. In preferential manner, the distance of movement of the second end 4a of the first spring 4 between the catch 3 in the release position and the catch 3 in the blocking position is smaller than the distance of movement of the first end 4a of the first spring 4 between the gate 2 in the closed position and the gate 2 in the fully open position.

In an advantageous embodiment illustrated in FIGS. 3 to 7, the radius of curvature of a first portion of the first spring 4 is substantially straight due to the presence of a guide whereas the second portion of the first spring 4 is curved. The guide imposes the shape of the first end 4a of the first spring 4. The guide is movable with respect to the body 1 and it is advantageous for the guide to form the contact interface between the first end 4a and the gate 2. The use of a guide that imposes a shape on the first spring 4 enables the free curved or straight shape to be modified.

In an advantageous configuration illustrated in FIGS. 3 to 7, the gate 2 is installed swivelling around a first pivot shaft 7 fixed to the body 1. The end 2a of the gate 2 opposite the end fixed to the body 1 moves along an arc of a circle which defines a first radius of curvature. In arbitrary manner, the sign of the radius of curvature is defined by the orientation of the vector that extends along a radius from the centre of the accessible arc of a circle. It is advantageous for the first spring 4 to be curved with a radius of curvature of opposite sign to the radius of curvature represented by the movement of end 2a. In other words, the movable end of the gate 2 and the first spring 4 present opposite curvatures, one is concave and the other is convex depending on whether the curvatures are observed from one end of the body or the other along the line BB represented in FIG. 1.

Advantageously, the catch 3 is installed swivelling with respect to the body 1. The catch 3 is installed swivelling with respect to a second pivot shaft 8 that is fixed to the body 1. The movable end that is farther away with respect to second pivot shaft 8 defines an arc of a circle. The first spring 4 is curved with a radius of curvature of opposite sign to the radius of curvature of the catch 3.

In preferential manner, the gate 2 has a force application point on the first spring 4 that is separated from the swivel axis of the gate 2 by a first distance. The catch 3 has a force application point on the first spring 4 that is separated from the swivel axis of the catch 3 by a second distance. The second distance is smaller than the first distance. Preferentially, the gate 2 has a force application point on the first spring 4 that is located between end 2a and the swivel axis of the gate 2.

Advantageously, the catch 3 has a force application point on the first spring 4 that is located between the actuation area of the catch 3 and the swivel axis of the catch 3.

By moving the force application point of the gate 2 away from the catch 3, a greater length of the first spring 4 is used thereby enabling a catch 3 to be obtained that is easier to move than the gate 2. In other words, the gate 2 presents a greater apparent stiffness thereby resulting in a faster return to the closed position.

In preferential manner, the axis connecting a first swivel axis 7 and a second swivel axis 8 is arranged on one side of the first spring 4 and does not pass through the first spring 4.

In a particular embodiment, the gate 2 is installed swivelling around the first swivel axis 7 defined by the first pivot shaft. The first end 4a of the first spring 4 is terminated by a head 6 installed swivelling around a defined third swivel axis that is parallel to first swivel axis 7. Preferentially, movement of end 2a of the gate 2 opposite the first pivot shaft 7 from the closed position to the open position results in movement of the second end 2b towards the central portion 1c of the body 1. Advantageously, an end 3c of the catch 3 opposite the second rotation shaft 8 moves towards the gate 2 when the catch 3 moves from the blocking position to the release position.

When the gate 2 swivels around the first pivot shaft 7 so as to toggle between the closed position and the open position, the first end 4a of the first spring 4 moves along the first housing 5. In addition to moving along the first housing 5, the head 6 swivels against the gate 2. Swivelling of the head 6 with respect to the gate 2 makes it possible to have a mechanical behaviour of the first spring 4 that is devoid of a flexion component with a force that is closer to a compression force along a longitudinal axis of the first spring 4 instead of combining a compression force and a flexion force.

In preferential manner, the carabiner is provided with a head 6 that performs the connection between the first end 4a of the first spring 4 and the gate 2. When the first spring 4 is a spring with non-contiguous turns, it is advantageous for the head 6 to define a hole receiving several turns of the first end 4a of the first spring 4. It is also advantageous for the catch 3 to have a nipple fixed to the first spring 4, for example a nipple inserted in the turns of the first spring 4. The end 3c can form the nipple.

It is advantageous for the head 6 to also form the guide so that the head 6 imposes the curvature of the part of the first end 4a of the first spring 4 located in the head 6. When the head 6 moves along the first housing 5, the curvature of this part of the first spring 4 is not modified. When the head 6 approaches the catch 3, turns of the first spring 4 can be inserted in the head 6. On the contrary, when the head 6 moves away from the catch 3, turns of the first spring 4 can leave the head 6. The turns arranged in the head 6 are blocked to prevent flexion of the turns with respect to one another. A flexion force may nevertheless arise for the turns situated outside the head 6. The flexion is observed perpendicularly to a longitudinal direction of the first spring 4.

When the gate 2 moves between the open position and the closed position, the head 6 moves along the first housing 5. The head 6 can slide along the first housing 5 and follows the curvature imposed by the first housing 5. The orientation of the head can be defined by its position along the first housing 5. The position of the head 6 in the first housing 5 is defined by the position of the gate 2 so that the position of the head 6 in the first housing 5 represents the intensity of the force applied on the gate 2. By defining the shape of the curvature of the first housing 5 or of the different curvatures of the first housing 5, it is possible to define the behaviour of the first spring 4 according to the force applied.

When the catch 3 is urged between the blocking position and the release position, the head 6 is pressing against the gate 2. The operation of the first spring 4 is hardly modified or is independent from the curvature of the first housing 5. When the gate 2 moves, the catch 3 is in the release position and the second end 4a fixed to the catch 3 is fixed or almost fixed with respect to the body 1. The variation of curvature along the first housing 5 with the possible successive variations of curvature enables the mechanical behaviour of the first spring 4 to be adjusted.

In advantageous manner, in the open position, the head 6 is pressing against an end-of-travel stop. In advantageous manner, in the open position of the gate 2 and in the release position of the catch 3, the first spring 4 is straight between its first end 4a and its second end 4b.

In a preferred embodiment, the gate 2 is installed swivelling with respect to the body 1 and the catch 3 is installed swivelling with respect to the body 1. The first end 4a is pressing on the gate 2 at a first distance with respect to the first swivel axis 7 and the second end 4a is pressing on the catch 3 at a second distance with respect to the second swivel axis 8. The second distance is smaller than the first distance to make it easier to obtain a different behaviour between a loading applied by the catch 3 and a loading applied by the gate 2.

To obtain a difference of behaviour, it is possible to use a first spring 4 that is a coil spring with non-contiguous turns with turns that are different between the first end 4a and the second end 4a, for example different materials or different separating distances between the turns. The above embodiments enable different behaviours to be had even when the first spring 4 is a coil spring with non-contiguous turns with turns that are identical from one end to the other.

In a preferential embodiment, the carabiner has a first spring 4 and a second spring 4 that are separated by the body 1 in a direction that is parallel to the swivel axis of the gate 2. The two springs are configured to work together. They are each functionally fixed to the gate 2 and to the catch 3.

In preferential manner, the first spring 4 and second spring 4 are fixed to one and the same head 6. The body 1 defines an aperture, i.e. a through hole. The head 6 passes through the body 1 and the two springs 4 are fixed to the head 6 on each side of the body 1.

In a preferential embodiment, a rod 9 is fixed to the catch 3 and runs inside a slide defined by the body 1 or by the gate 2. In the illustrated embodiment, the slide is defined by the gate 2. When the gate 2 moves from the closed position to the open position, the slide 10 slides with respect to the rod 9. When the catch moves between the blocking position and the release position, the rod 9 moves with respect to the body 1 and with respect to the slide 10.

For example purposes, the slide 10 presents a general L-shape. In the blocking position, the rod 9 is on one branch of the L which prevents movement of the gate 2. When movement takes place from the blocking position to the release position, the rod 9 leaves the one branch of the L to reach another branch of the L allowing movement of the gate 2. When the gate 2 moves by swivelling, the branch is in the form of an arc of a circle.

In a particular configuration, the slide 10 is defined in the first wing 3a and in the second wing 3a if applicable. It is preferable for the slide 10 to open into the through hole delineated by the gate 2 and the body 1. In preferential manner, the rod 9 presents a complementary or substantially complementary cross-section to the cross-section of the slide 10. By using a complementary cross-section, penetration of dust and mud through the slide 10 is limited. Preferentially, the rod 9 is pressing against the body 1 when the catch 3 is in the release position thereby limiting the transit of mud and dust to the cavity.

It is particularly advantageous, in the closed position, for the slide 10 to be mainly located inside a ring delineated by the body 1 and the part of the gate 2 connecting the first end 2a and the second end 2b when the carabiner is observed in a direction parallel to the first swivel axis.

In preferential manner, the second end 2b of the gate 2 is solid and defines a through hole receiving the second end portion 1b of the body 1 in the closed position.

It is particularly advantageous to use such a carabiner in a lanyard. A wire element is fixed in removable or unremovable manner to the carabiner. The body can define a through passage and the wire element passes round the through passage. The wire element can be a static wire element or a dynamic wire element. A dynamic wire element has an elongation capacity of more than 6%, for example comprised between 8% and 20%. A static wire element has an elongation capacity of less than 4%.

In preferential manner, the carabiner belongs to a via ferrata lanyard comprising an energy absorber in case of a fall.

1. Lockable carabiner for mountaineering and work at heights comprising:
a C-shaped body provided with a first end portion and a second end portion connected by a central portion;
a gate having a first end and a second end, the first end of the gate being fixed to the first end portion of the body, the gate being arranged swivelling between a closed position and an open position, the second end of the gate moving with respect to the second end portion of the body when the gate moves between the open position and the closed position, the gate and body defining a ring when the gate is in the closed position;
a catch fixed to the body and fitted movable between a blocking position and a release position, the blocking position blocking the gate in the closed position, the release position allowing movement of the gate between the closed position and the open position;
a first spring and a second spring each having a first end connected to the gate and a second end connected to the catch, the first spring and second spring each biasing the gate so that a rest position of the gate is the closed position and biasing the catch so that a rest position of the catch is the blocking position, the first spring and second spring being devoid of direct attachment point with the body;
wherein the first spring and second spring are separated by the body.

2. Lockable carabiner according to claim 1 wherein the first spring and second spring have the same length and the same stiffness.

3. Lockable carabiner according to claim 1 wherein the gate has a first wing and a second wing, the body being arranged between the first wing and second wing in the open position and in the closed position.

4. Lockable carabiner according to claim 3 wherein the first wing and second wing of the gate present a coverage surface with the body that is larger in the open position than in the closed position, the coverage surface being observed in a direction parallel to the swivel axis of the gate.

5. Lockable carabiner according to claim 3 wherein the first wing and second wing slide against the body.

6. Lockable carabiner according to claim 1 wherein the catch is U-shaped comprising two wings connected by a joining wall, the catch and body defining a cavity receiving the first spring and second spring.

7. Lockable carabiner according to claim 6 wherein the first wing of the gate is arranged between the body and the first wing of the catch and wherein the second wing of the gate is arranged between the body and the second wing of the catch.

8. Lockable carabiner according to claim 7 wherein the cavity receiving the first spring and second spring is delineated by the first wing and second wing of the gate, the first wing of the catch sliding against the first wing of the gate and the second wing of the catch sliding against the second wing of the gate.

9. Lockable carabiner according to claim 6 wherein, in the release position, the joining wall is pressing against the body.

10. Lockable carabiner according to claim 1 wherein the gate is arranged swivelling around a first swivel axis and the first end of the first spring is terminated by a head arranged swivelling around a swivel axis that is parallel to the first swivel axis.

11. Lockable carabiner according to claim 10 wherein the first spring is a coil spring with non-contiguous turns and wherein a few turns of the first end are blocked by the head to prevent flexion of said a few turns.

12. Lockable carabiner according to claim 10 wherein, in the open position, the head is up against an end-of-travel stop defined by the body.

13. Lockable carabiner according to claim 10 wherein the body defines an aperture and the head extends on each side of the body through the aperture to receive the first end of the first spring and the first end of the second spring.

14. Lockable carabiner according to claim 1 wherein the gate is arranged swivelling with respect to the body around a first pivot shaft and the catch is arranged swivelling with respect to the body around a second pivot shaft and wherein the first end presses on the gate at a first distance from the first pivot shaft and the second end presses on the catch at a second distance from the second pivot shaft, the second distance being smaller than the first distance, and wherein an axis connecting the first pivot shaft and the second pivot shaft is arranged totally on one side of a plane passing through the first spring and the second spring.

15. Lockable carabiner according to claim 1 wherein the gate defines a slide, the slide being installed swivelling with respect to the body when the gate moves between the closed position and the open position, and wherein the catch has a rod, the rod being installed movable with respect to the body and with respect to the slide when the catch moves between the blocking position and the release position, the slide being arranged on the same side of the central portion as the second end of the gate in an observation in a direction parallel to the swivel axis of the gate.

16. Method for opening a carabiner comprising the following steps:
providing a carabiner according to claim 1;
moving the catch from the blocking position to the release position;
moving the gate from the closed position to the open position.
